(19) United States
(12) Patent Application Publication
(10) Pub. No.: US 2015/0186426 A1
(43) Pub. Date: Jul. 2, 2015

(54) SEARCHING INFORMATION USING SMART GLASSES

(71) Applicant: KT CORPORATION, Gyeonggi-do (KR)

(72) Inventors: Yeong-Hwan JEONG, Seoul (KR); Bum-Joon PARK, Chungcheongbuk-do (KR); Hyun-Sook KIM, Seoul (KR); Ji-Wan SONG, Seoul (KR)

(21) Appl. No.: 14/585,416

(22) Filed: Dec. 30, 2014

(30) Foreign Application Priority Data
Dec. 30, 2013 (KR) 10-2013-0166469

(51) Int. Cl. G06F 17/30; G06K 9/00

(52) U.S. Cl. CPC G06F 17/30268; G06F 17/3087; G06K 9/00671

(57) ABSTRACT

The disclosure is related to a method of providing a search service by a service server using a plurality of wearable computing devices registered at the service server for the search service. The method may include selecting wearable computing devices located within a predetermined distance from a target search location among the registered wearable computing devices, requesting the selected wearable computing devices to collect information on a target search object through a communication network, receiving the requested information from the selected wearable computing devices through the communication network, and providing the received information to user equipment that requests searching information on the target search location and the target search object.

### CROSS REFERENCE TO PRIOR APPLICATIONS

The present application claims priority under 35 U.S.C. §119 to Korean Patent Application No. 10-2013-0166469 (filed on Dec. 30, 2013).

### BACKGROUND

The present disclosure relates to searching information using wearable computing devices and, more particularly, to providing, as a searching result, images captured by a plurality of smart glasses.

Lately, various types of wearable devices such as a smart watch and smart glasses have been introduced. Among them, smart glasses have been receiving attention. Such smart glasses communicate with other devices, automatically capture images that an associated user looks at, and share the captured images with friends or family members. The captured images may include a lot of objects such as building, people, trees, vehicles, and so forth. By analyzing the objects in the captured images, many facts could be determined, such as weather condition, traffic state, accidents, and so forth. That is, the captured images of smart glasses could be very valuable information for other users.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, information collected by a plurality of wearable computing devices may be provided to user equipment of a registered user in response to a search request of a target search object from the registered user.

In accordance with another aspect of the present invention, smart glasses may be selected based on a target search location and a target search object and captured images of the selected smart glasses may be provided as a search result.

In accordance with at least one embodiment, a method may be provided for providing a search service by a service server using a plurality of wearable computing devices registered at the service server for the search service. The method may include selecting wearable computing devices located within a predetermined distance from a target search location among the registered wearable computing devices, requesting the selected wearable computing devices to collect information on a target search object through a communication network, receiving the requested information from the selected wearable computing devices through the communication network, and providing the received information to user equipment that requests searching information on the target search location and the target search object.

The method may further include regularly receiving device information from the registered wearable computing devices through the communication network, wherein the device information includes information on at least one of a location, a traveling speed, and a time of each registered wearable computing device, receiving a search request message from the registered user equipment, and extracting information on the target search location and the target search object from the search request message. Wearable computing devices located within a predetermined distance from the target search location are selected based on the device information of the wearable computing devices and the extracted target search location.

The selecting may include deciding a selection radius based on at least one of the target search location and the target search object, and selecting wearable computing devices located within the decided selection radius from the target search location.

The selecting may include detecting wearable computing devices located within the predetermined distance from a location of the user equipment and selecting the detected wearable computing devices to request the information on the target search object.

The receiving may include analyzing the received information of each one of the selected wearable computing devices and determining whether the received information is related to the target search object, selecting one matched with reference information from the received information related to the target search object, as a representative wearable computing device, and requesting the representative wearable computing device to collect and provide information on the target search object.

The receiving may include analyzing the received information of each one of the selected wearable computing devices and determining whether the received information is related to the target search object, selecting wearable computing devices providing the information related to the target search object based on the determination result, grouping the selected candidate wearable computing devices as a candidate group, selecting one from the candidate group as a representative wearable computing device, and requesting the representative wearable computing device to collect and provide information on the target search object.

The selecting candidate wearable computing devices may include selecting wearable computing devices providing information on the target search object, having a same traveling speed, and located in a comparatively close distance and grouping the selected wearable computing devices as the candidate group.

The method may further include detecting the representative wearable computing device becoming unable to provide information on the target search object, reselecting one from the candidate group as a new representative wearable computing device, and requesting the new representative wearable computing device to collect and provide information on the target search object.

In accordance with another embodiment, a method may be provided for providing a search service by a server using a plurality of smart glasses registered at the server for the search service. The method may include receiving a search request message from user equipment with information on a target search object and a target search location through a communication network, selecting smart glasses located within a predetermined distance from a target search location among the registered smart glasses, requesting the selected smart glasses to capture and provide images of the target search object, and receiving the requested images from the selected smart glasses and providing the received images to the user equipment as a search result.

The method may further include receiving a control signal for controlling at least one of a photographing angle and a photographing distance of the selected smart glasses from the user equipment and requesting the selected smart glasses to capture images of the target search object based on at least one of the photographic angle and the photographing distance.

The method may further include receiving images, captured from at least one of the requested photographing distance and the requested photographing angle, from the requested smart glasses and providing the received images to the user equipment as the search result.

In accordance with still another embodiment, a method may be provided for searching information using a plurality of wearable computing devices. The method may include transmitting a search request message to the server with information on a target search location and a target search object through a communication network and receiving information on the target search object from the server, as a search result. The received information may be collected and provided from at least one wearable computing device located at the target search location.

The receiving may include receiving images of the target search object from the server, as the search result, wherein the images captured in real time from representative smart glasses selected from a plurality of smart glasses located within a predetermined distance from the target search location.

The receiving may include receiving a plurality of candidate images from the server, as the search result, wherein the candidate images are captured by a plurality of smart glasses located within a predetermined distance from the target search location, receiving a user input to select one of the candidate images as a representative image and transmit the information on the representative image to the server, and receiving images captured in real time from a smart glasses that transmits the representative image through the server.

### BRIEF DESCRIPTION OF THE DRAWINGS

The above and/or other aspects of some embodiments of the present invention will become apparent and more readily appreciated from the following description of embodiments, taken in conjunction with the accompanying drawings, of which:

FIG. 1 illustrates an overview for providing a search service using smart glasses in accordance with at least one embodiment;

FIG. 2 illustrates smart glasses in accordance with at least one embodiment;

FIG. 3 illustrates a service server in accordance with at least one embodiment;

FIG. 4 illustrates transmitting a search request message in accordance with at least one embodiment;

FIG. 5 illustrates analyzing a search request message in accordance with at least one embodiment;

FIG. 6 illustrates selecting target smart glasses in accordance with at least one embodiment;

FIG. 7 illustrates providing real-time images in accordance with at least one embodiment;

FIG. 8 illustrates identifying objects in images in accordance with at least one embodiment;

FIG. 9 illustrates selecting a representative image in accordance with at least one embodiment;

FIG. 10 illustrates selecting a search radius and candidate smart glasses in accordance with at least one embodiment;

FIG. 11 illustrates providing images of a target search object seamlessly in accordance with at least one embodiment;

FIG. 12 illustrates a graphic user interface for providing images from smart glasses in accordance with at least one embodiment; and

FIG. 13 illustrates a method of providing a search service using a plurality of smart glasses in accordance with at least one embodiment.

### DETAILED DESCRIPTION OF EMBODIMENTS

Reference will now be made in detail to exemplary embodiments of the present invention, examples of which are illustrated in the accompanying drawings, wherein like reference numerals refer to like elements throughout. The embodiments are described below, in order to explain embodiments of the present invention by referring to the figures.

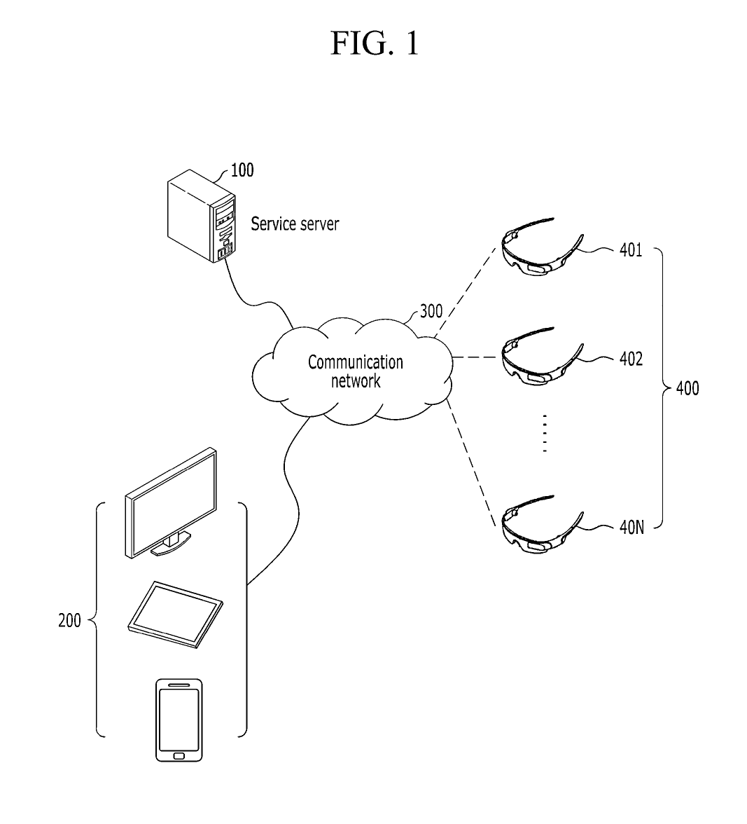

In accordance with at least one embodiment, a plurality of wearable computing devices, such as smart glasses, may be used to provide a search service. In particular, wearable computing devices collecting information on a target search object may be selected based on information on a target search location and a target search object and the collected information of the selected wearable computing devices may be provided to a user as the search result. Hereinafter, such a search service using wearable computing devices will be described with reference to FIG. 1.

FIG. 1 illustrates an overview for providing a search service using smart glasses in accordance with at least one embodiment.

Referring to FIG. 1, service server 100 may provide a search service using various types of information collected by a plurality of wearable computing devices, such as smart glasses 401 to 40N in accordance with at least one embodiment. In particular, service server 100 may receive a search request message from user equipment 200 registered for a search service and provide, as a search result, real-time images having a target search object to search, which are captured by a plurality of smart glasses 401 to 40N.

A wearable computing device denotes an electronic device capable of communication, processing data to perform a predetermined operation, storing programs and data being produced during execution of a predetermined operation, and sensors for collecting various types of information, such as a camera. For example, the wearable computing device may include a smart watch (e.g., iwatch and Samsung gear) and a smart glasses (e.g., google glasses), and so forth. For convenience and ease of understanding, the smart glasses will be described as a representative example of the wearable computing device, but the present invention is not limited thereto.

User equipment 200 may be an electronic device of a user for i) requesting service server 100 to search a target search object, ii) receiving a search result from service server 100, and iii) providing the received search result to a user. For example, user equipment 200 may receive images of a target search object to search, as a search result, from service server 100 and display the received images through a display.

Such user equipment 200 may be an electronic device capable of communicating with other entities through communication network 300, processing a predetermined operation with data stored in a memory, storing applications and data, receiving various types of user inputs, and outputting results of a predetermined operation. For example, user equipment 200 may include a personal computer, a smart television, a smart phone, a tablet PC, and so forth.

In particular, user equipment 200 may receive a user input to request searching a target search object from an associated user. Such a user input may include a voice input, image data, and/or text data. Furthermore, such a user input may include information on a target search location and a target search object.

Service server 100 may be a computing system of a service provider. Service server 100 may receive a search request from user equipment 200 and provide images captured by smart glasses 401 to 40N as a search result to user equipment 200. In particular, service server 100 may receive a registration request message from a user of smart glasses or user equipment and register the user for a search service. Once a user is registered for the search service, service server 100 may collect information from the registered smart glasses and provide the collected information to other registered user as a search result in accordance with at least one embodiment.

In particular, service server 100 may receive a search request message from user equipment 200 and determine a target search location and a target search object to search by analyzing the search request message. Service server 100 may select registered smart glasses based on the target search location and request at least one selected smart glasses to provide real-time images. In response to the request, service server 100 may receive images from the selected smart glasses and select a representative image from the received images based on the target search location and the target search object to search. Service server 100 may transmit the selected representative image to user equipment 200 as a search result.

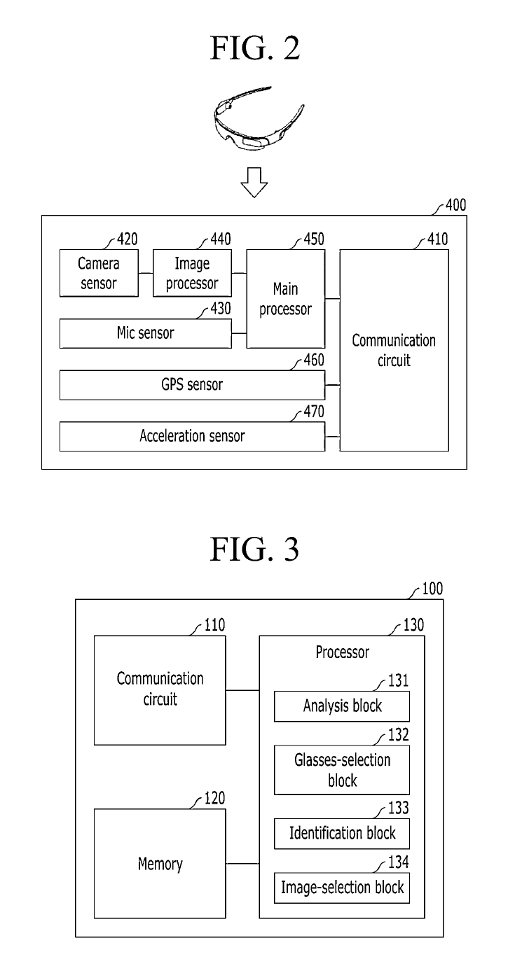

As described, smart glasses 400 may be worn by a registered user and capture real-time images in a view point of the registered user. Such registered users may be distributed over all around world. Accordingly, service server 100 may collect images of unlimited objects from registered smart glasses. Hereinafter, such a smart glasses 400 will be described with reference to FIG. 2.

FIG. 2 illustrates smart glasses in accordance with at least one embodiment.

Referring to FIG. 2, smart glasses 400 may include: i) communication circuit 410 configured to communication with service server 100; ii) camera sensor 420 configured to capture real-time images; iii) Mic sensor 430 configured to receive a voice control message and to record audio such as voice and sound; iv) image processor 440 configured to extract information on objects in the captured images; v) main processor 450 configured to video data by combining the audio and the image; vi) GPS sensor 460 configured to generate location information of smart glasses 400; and vii) acceleration sensor 470 configured to measure a travel speed.

In accordance with at least one embodiment, registered smart glasses may regularly transmit information on a location and a traveling speed to service server 100. Based on such location and speed information of each registered smart glasses, service server 100 may detect smart glasses located in a target search location. When the selected smart glasses receives a request message of providing images, the selected smart glasses provides the captured images to service server 100.

Hereinafter, service server 100 will be described with reference to FIG. 3. FIG. 3 illustrates a service server in accordance with at least one embodiment. Referring to FIG. 3, service server 100 may include communication circuit 110, memory 120, and processor 130.

Communication circuit 110 may be a circuitry for enabling service server 100 to communicate with other entities including user equipment 200 and smart glasses 401 to 40N through communication network 300 based on various types of communication schemes. For example, communication circuit 110 may be referred to as a transceiver or a transmitter—receiver. In general, communication circuit 110 may transmit data to or receive data from other entities coupled to a communication network. For convenience and ease of understanding, electronic device 100 is illustrated as having one communication circuit in FIG. 2, but the present invention is not limited thereto. For example, service server 100 may include more than two communication circuits each employing different communication scheme. Communication circuit 110 may include at least one of a mobile communication circuit, a wireless internet circuit, a near field communication (NFC) circuit, a global positioning signal receiving circuit, and so forth. Particularly, communication circuit 101 may include a short distance communication circuit for short distance communication, such as NFC, and a mobile communication circuit for long range communication through a mobile communication network, such as long term evolution (LTE) communication or wireless data communication (e.g., WiFi).

In accordance with at least one embodiment, communication circuit 110 may receive a search request message from user equipment 200, receive images of a target search object from smart glasses 400, and transmit the received images to user equipment 200 as a search result. Furthermore, communication circuit 110 may receive device information from smart glasses 400.

Memory 120 may be a circuitry for storing various types of digital data including an operating system, at least one application, information and data necessary for performing operations. In accordance with at least one embodiment, memory 120 may store a database for storing and managing device information of smart glasses (e.g., current location, traveling speed), supplementary information searched based on the device information, images received from smart glasses, information on user equipment 200, and information on a target search location and a target search object received from user equipment 200.

Processor 130 may be a central processing unit (CPU) that carries out the instructions of a predetermined program stored in memory 103 by performing basic arithmetic, logical, control and input/output operations specified by the instructions. In accordance with at least one embodiment, processor 130 may perform various types of operations for collecting information from wearable computing devices (e.g., smart glasses) and providing collected information to user equipment 200 as a search result.

In particular, processor 130 may perform: i) an operation for collecting device information from registered smart glasses; ii) an operation for analyzing the received search request message; iii) an operation for selecting smart glasses based on a target search location; iv) an operation for requesting the selected smart glasses to provide images and receiving images of target search object; v) an operation for identifying and recognizing objects in the images; vi) an operation for grouping candidate smart glasses to a candidate group; vii) an operation for selecting a representative smart glasses; and viii) an operation for providing a representative image from the representative smart glasses.

Processor 130 may further include: i) analysis block 131 configured to analyze a search request message received from user equipment 200 through communication circuit 110; ii) smart glasses-selection block 132 configured to select smart glasses based on a target search location; identification block 133; and iii) image-selection block 134 configured to select representative images from images received from smart glasses 400.

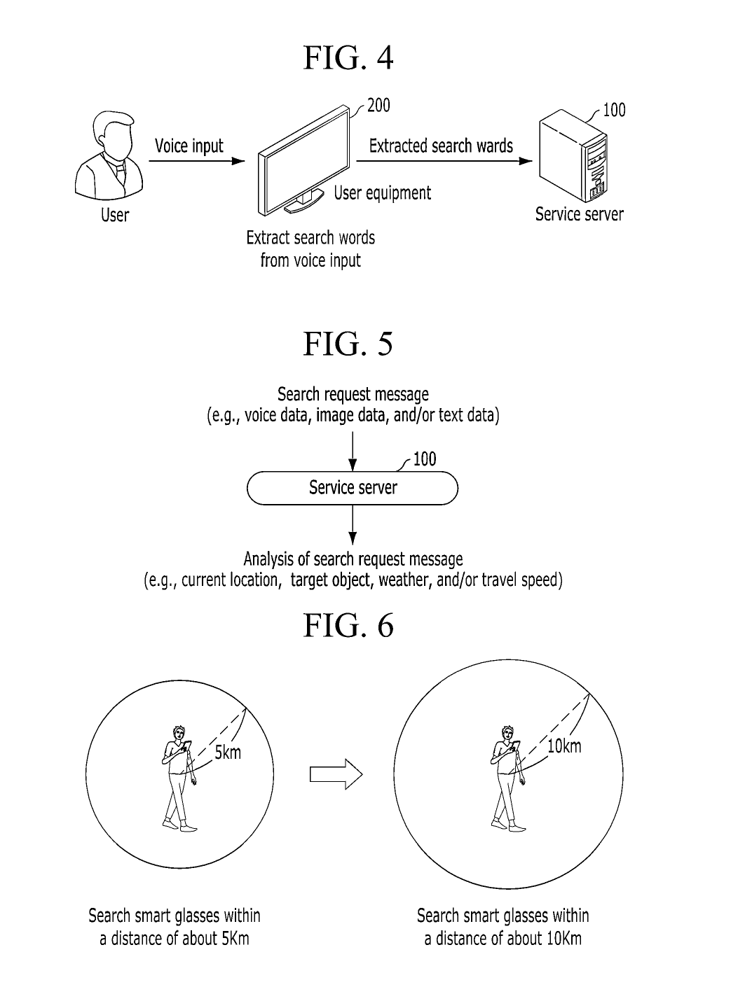

Hereinafter, operations of user equipment 200 and service server 100 to provide a search service will be described in detail with reference to FIG. 4 to FIG. 12.

First, user equipment 200 transmits a search request message to service server 100. FIG. 4 illustrates transmitting a search request message in accordance with at least one embodiment.

As shown in FIG. 4, user equipment 200 may receive a search request command from a user in a voice input. User equipment 200 may divide the received voice input into words, extract search words (e.g., a target search location and a target search object) from the search request, generate a search request message to include information on the target search location and the target search object, and transmit the generated search request message to service server 100. That is, user equipment 200 may extract nouns from the voice input, detect any extracted nouns related to a location and an object, and select a target search location and a target search object from the extracted nouns.

The present invention, however, is not limited thereto. For example, user equipment 200 may receive a search request command in a text format (e.g., text input) or additionally receive information on a target search location and a target search object from a user. In addition, such extraction operation may be performed by service server 100. In this case, user equipment 200 may include information on the search request command from the user in the search request message and transmit the search request message to service server 100.

Furthermore, such operation for receiving a search request command and related information may be performed through a graphic user interface produced as a result of executing a predetermined application installed in user equipment 200 and displayed on user equipment 200. Such a predetermined application may be downloaded from service server 100 when user equipment 200 registers at service server 100 for the search service. A graphic user interface, produced and displayed as a result of executing the predetermined application, may enable the user to register for the search service, to request a search service, to enter necessary information to search a target search object, and to receive a search result from service server 100.

Second, service server 100 analyzes the search request message from user equipment 200. FIG. 5 illustrates analyzing a search request message in accordance with at least one embodiment. As shown in FIG. 5, service server 100 may receive a search request message from user equipment 200. Such a search request message may include at least one of voice data, image data, and text data. The search request message may include information on a target search location and a target search object. Service server 100 may extract the information on the target search location and the target search object from the search request message. In addition, service server 100 may analyze supplementary information included in the search request message when the search request message includes information on the search request command received from user equipment 100. In this case, search server 100 may obtain information on images or voice related to the target search location and the target search object. Service server 100 may use such obtained information to search supplementary information, such as weather, traffic status, attraction points, restaurant information, news, and so forth.

Third, after obtaining the information on the target search location and the target search object, service server 100 selects target smart glasses based on the obtained information on the target search location and the target search object. FIG. 6 illustrates selecting target smart glasses in accordance with at least one embodiment.

As shown in FIG. 6, service server 100 may decide a search radius based on a target search location and a target search object in accordance with at least one embodiment. Service server 100 may decide such a search radius based on a search policy. Such a search policy and/or a search radius may be set by at last one of a system designer, a service provider, an operator, and a user. For example, the search radius may be set based on the target search location, as shown in 910 and 920 in FIG. 10. As shown, when a target search location is river, a search radius may be set 50m, but the present invention is not limited thereto.

For example, service server 100 may decide 5 Km radius as a search radius or 10 Km radius as a search radius. The search radius may vary according to the target search location and the target search object. For example, the target search object is comparatively large object service server 100 may decide a comparatively large search radius. Service server 100 may decide a search radius 100 times larger than a size of a target search object, but the present invention is not limited thereto.

After deciding the search radius, service server 100 may select registered smart glasses located within the search radius. In particular, service server 100 may select registered smart glasses i) located within the search radius from in about a center of the target search location and ii) capturing images of the target search object.

When a search request message excludes information on a target search location, service server 100 may decide a target search location as a current location of user equipment 200.

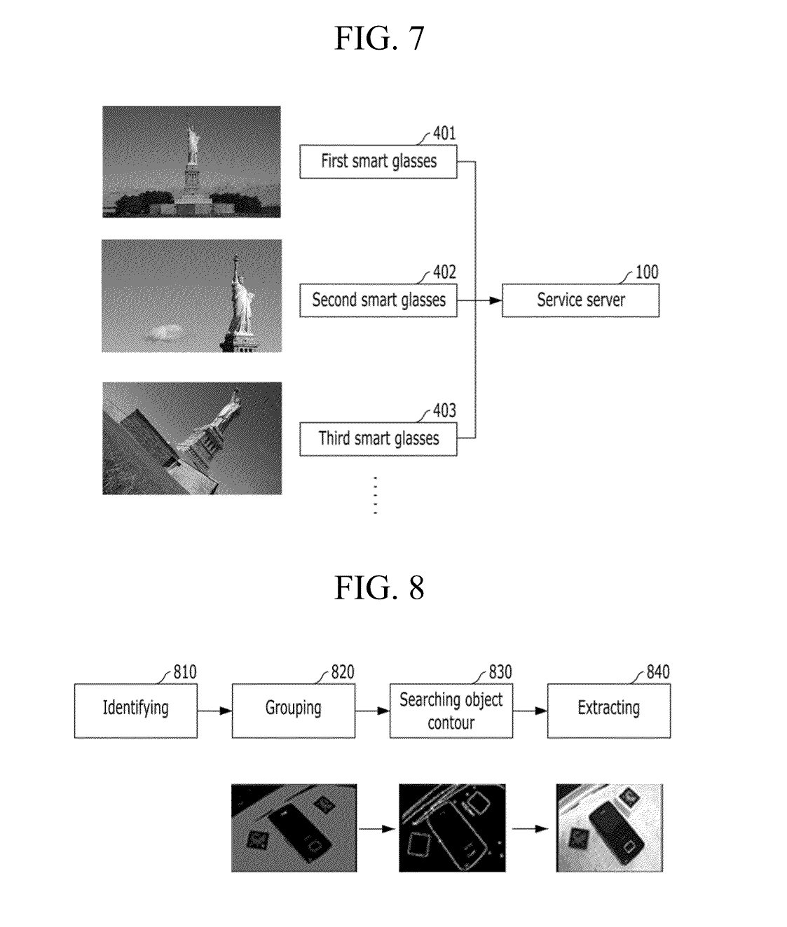

After searching the target smart glasses, service server 100 may transmit an information request message to the selected smart glasses in accordance with at least one embodiment. In response to the information request message, the selected smart glasses (e.g., 401, 402, and 403) capture real-time images of a target search object or a target search location and provide the captured images to service server. FIG. 7 illustrates providing real-time images in accordance with at least one embodiment.

As shown in FIG. 7, when smart glasses 401 to 403 are selected as target smart glasses to obtain images, service server 100 may transmit an information request message to smart glasses 401 to 403. Then, smart glasses 401 to 403 may provide images captured at a target search location or of a target search object to service server 100. Service server 100 may store the received images in a predetermine database in connection with information on associated smart glasses.

When no smart glasses are found within a search radius, service server 100 may provide images captured in a past and stored in the predetermined database to user equipment 200 as a search result.

Service server 100 may identify objects in the received images in accordance with at least one embodiment. For example, when a target search object is “apple” or “the Statue of Liberty”, service server 100 may select images of apple or the Status of Liberty from the received images. In order to select, service server 100 needs to identify objects in the images. FIG. 8 illustrates identifying objects in images in accordance with at least one embodiment.

As shown in FIG. 8, such operation may be performed through i) identifying 810, ii) grouping 820, iii) searching object contour 830, and iv) extracting 840. For example, processor 130 of service server 100 identifies image data of objects in an image, groups identified image data by each object, and detects a contour of the grouped object. Processor 130 may extract object information, such as a size, an area, a length, and so forth. Based on such extracted object information, processor 130 may identify objects in an image.

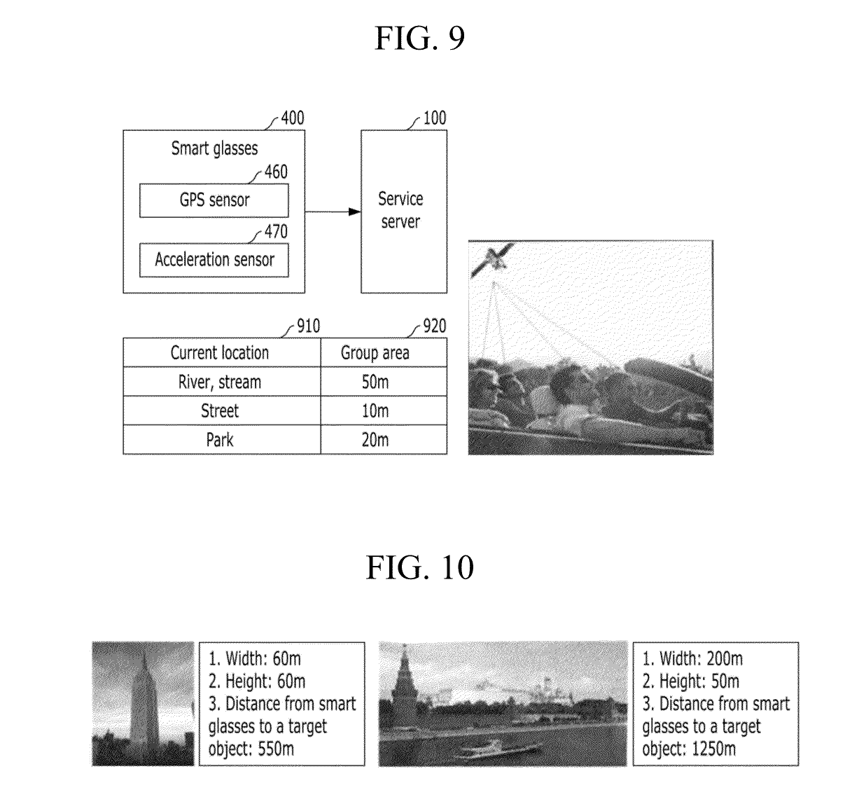

Service server 100 may select a representative image from the identified images of the target search object. FIG. 9 illustrates selecting a representative image in accordance with at least one embodiment. As shown in FIG. 9, service server 100 may compare the extracted object information (e.g., a size of an object, a width, a height, a distance, and a view angle) of image with reference information. The distance may be a distance between smart glasses and the target search object.

After selecting the representative image, service server 100 may determine smart glasses providing the representative image as a representative smart glasses and provide images from the representative smart glasses to user equipment 200. Since smart glasses always travel to a predetermined direction, the representative smart glasses might become unable to capture a target search object. That is, the representative smart glasses might get out of the target search location or change a view point to other direction. In this case, service server 100 may select a representative image and representative smart glasses again.

In order to seamlessly provide images as a search result, service server 100 may select candidate smart glasses providing images of the target search object and group the selected smart glasses as a candidate group. FIG. 10 illustrates selecting a search radius and candidate smart glasses in accordance with at least one embodiment. As shown in FIG. 10, service server 100 may select smart glasses providing images of the target search object as candidate smart glasses and group the candidate smart glasses into a candidate group. For example, service server 100 may group multiple smart glasses into one candidate group based on a traveling speed of smart glasses. Service server 100 may detect smart glasses located within a comparatively short radius and having the same traveling speed and determine the detected smart glasses as being travelling with the same vehicle. Such traveling speed information may be obtained and calculated in GPS sensor 460 and acceleration sensor 470 of smart glasses 400 and regularly provided to service server 100, as shown in FIG. 10.

When a target search location 910 is street 920, service server 100 may select smart glasses providing images of a target search object in 10m search radius from the target search location as candidate smart glasses and group the selected smart glasses as a candidate group.

As described, the candidate smart glasses are grouped to a candidate group for providing images, as a search result, to user equipment 200, seamlessly. That is, when representative smart glasses become unable to provide images of a target search object, one of smart glasses in the candidate group may be selected and images captured by the selected one may be provided to user equipment 200 seamlessly. In addition, service server 100 may delay providing the received images at a predetermined interval. The predetermined interval may be equivalent to a maximum time for reselecting representative smart glasses from the candidate group after current representative smart glasses becomes unable to provide images of a target search object.

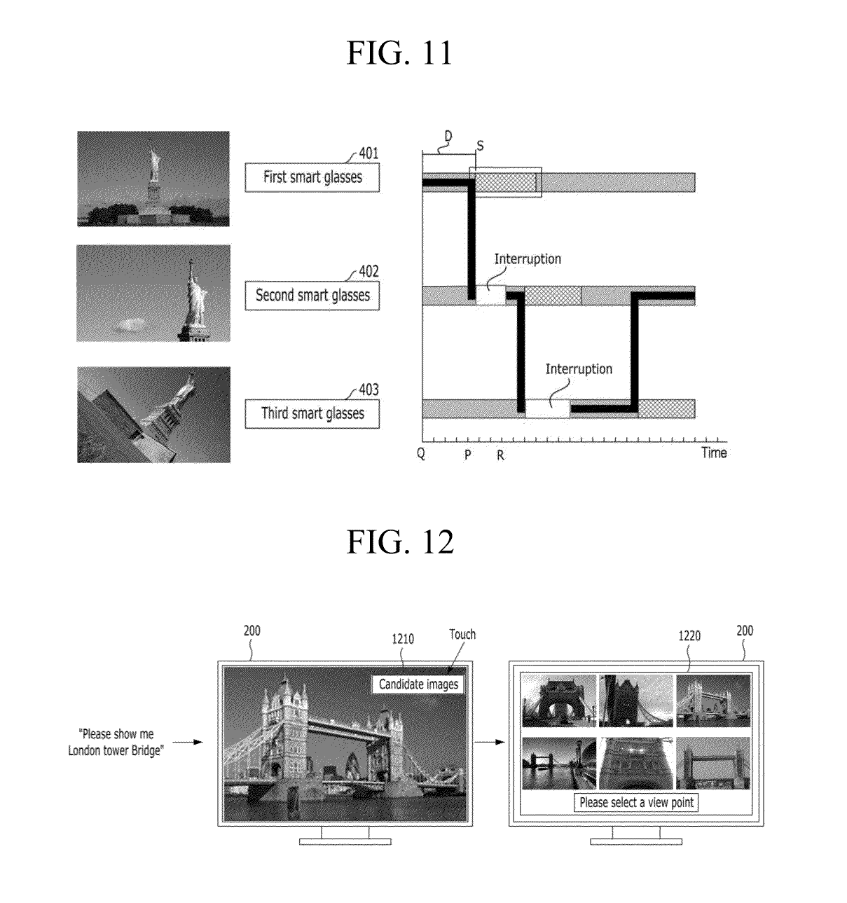

FIG. 11 illustrates providing images of a target search object seamlessly in accordance with at least one embodiment. As shown in FIG. 11, first to third smart glasses 401 to 403 are grouped as a candidate group. First smart glasses 401 is selected as a representative smart glasses and provides images of a target search object (e.g., the Statue of Liberty) at a time Q. At a time P, first smart glasses 401 become unable to send images of the Statue of Liberty. Then, service server 100 reselects second smart glasses 402 from the candidate group as representative smart glasses at a time P and continuously provides the images to user equipment 200 at a time R. Accordingly, a service of providing images may be interrupted from the time P to the time R while reselecting second smart glasses 402 as new representative smart glasses.

In order to provide a service seamlessly, service server 100 delays transmission of images from first smart glasses 401 as much as a delay D, which is greater than a time of reselecting another representative smart glasses. So, service server 100 starts transmitting images of first smart glasses 401 at a time S.

In accordance with at least one embodiment, service server 100 may provide images from all of candidate smart glasses in response to a user input and enable a user to select one of the provided images as a representative image. FIG. 12 illustrates a graphic user interface for providing images from smart glasses in accordance with at least one embodiment. As shown in FIG. 12, user equipment 200 may produce and display a graphic user interface for displaying images from a representative image (e.g., London Tower Bridge) with icon 1210 that enables a user to request candidate images. When a user makes a touch input on icon 1210, a graphic user interface may display images 1220 of all candidate smart glasses. When a user selects one of candidate images, service server 100 may reselect smart glasses associated with the selected image as a representative smart glasses and provide images thereof as representative images.

In accordance with at least one embodiment, service server 100 may receive a control signal from user equipment 200 to control the representative smart glass. Such a control signal may include information on a photographing angle, a photographing distance, or a photographing location. Service server 100 may transmit a control request message to the representative smart glasses and request the representative smart glasses to control the representative smart glasses based on information on the control signal. Upon consent of a user of the representative smart glasses, the representative smart glasses may be controlled based on the control signal. Accordingly, service server 100 may receive customized images from the representative smart glasses and provide the received images to user equipment 200.

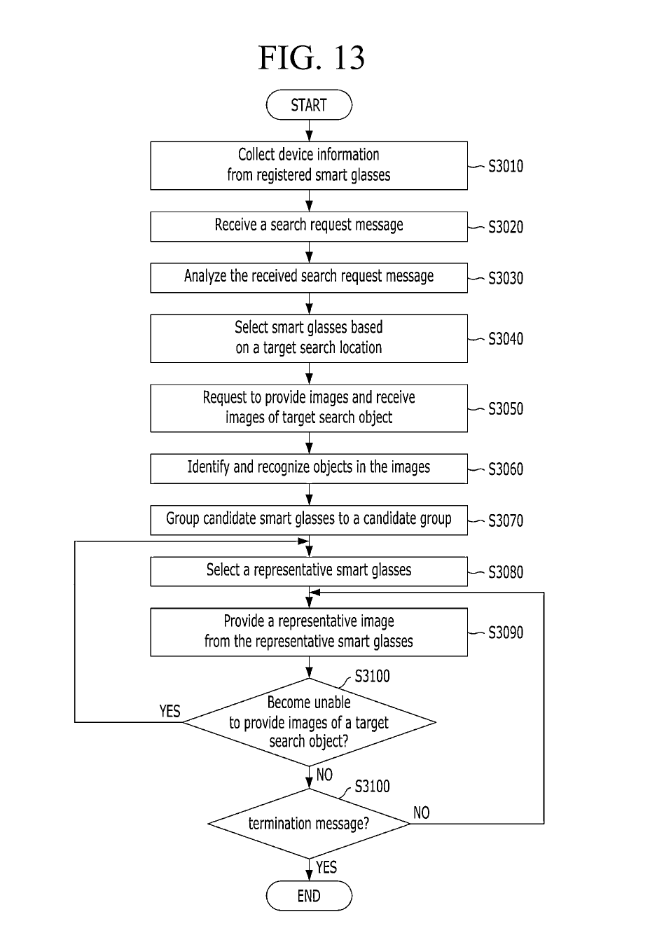

Hereinafter, a search service operation of a service server will be described with reference to FIG. 13. FIG. 13 illustrates a method of providing a search service using a plurality of smart glasses in accordance with at least one embodiment.

Referring to FIG. 13, service server 100 may regularly collect real-time device information on registered smart glasses and store the collected real-time device information in a predetermined database at step S3010. The real-time device information may include information on a current location, a current travel speed, and a current time of a corresponding smart glasses 400. Based on the device information, service server 100 may collect supplemental information on weather, traffic status, and associated news based on the current location and the current time of corresponding smart glasses 400 and store the searched supplemental information in connection with real-time device information of corresponding smart glasses in database of memory 130. Such supplemental information may be provided to a user. For example, service server 100 may receive a voice input as “What is weather in New York” with a search request message. In this case, service server 100 may search weather information in New York as supplementary information.

At step S3020, service server 100 may receive a search request message from user equipment 200. The search request message may be include at least one of voice data, image data, and text data, but the present invention is not limited thereto. The search request message may include information a target search location and/or a target search object.

At step S3030, service server 100 may analyze the search request message. Service server 100 may extract information on the target search location and the target search object to search from the search request message. The search request message may include information on words extracted from a voice input from an associated user. For example, when service server 100 receives a search request message in a voice data format, service server 100 may perform a context analysis process and a word extraction process to extract information on a target search location and a target search object to search from the search request message. Such extracted information on the target search location and the target search object may be keyword information.

At step S3040, service server 100 may select at least one of smart glasses 400 based on the information on the target search location and the target search object. For example, service server 100 may select smart glasses location within a predetermined distance radius from a target search location. When the search request message does not include information on a target search location, service server 100 detects a location of a user (e.g., user equipment 200) and selects at least one of smart glasses 400 located within a predetermined distance radius from the detected location of the user. Due to the absence of the target search location information, service server 100 searches information based on the target search object information.

At step S3050, service server 100 may request the selected smart glasses to provide images and receive real-time images of a target search object or a target search location from the selected smart glasses 400. Service server 100 may store the received real-time images of the target search object or the target search location received from selected smart glasses 400.

At step S3060, service server 100 may identify and recognize objects in the received images through an image analysis process. The information on the identified objects may be stored in the database in connection with the real-time image information.

At step S3070, service server 100 may select candidate smart glasses and group the selected candidate smart glasses as a candidate group. For example, service server 100 may select, as candidate smart glasses, smart glasses located within a predetermined radius and/or having a similar traveling speed from the smart glasses selected at step S3040 and providing images at step S3050. Service server 100 groups the selected candidate smart glasses as a candidate group.

At step S3080, service server 100 may select a representative image from candidate images by comparing received images with reference information. For example, among candidate images, one matched with the reference information may be selected as a representative image. The reference information may include a size of the target search object, a photographic angle, and/or a distance from a target search object and smart glasses. Furthermore, service server 100 may select smart glasses providing the representative image as representative smart glass.

At step S3090, service server 100 may provide images from the representative smart glasses as a search result to user equipment 200. For example, service server 100 may provide the images with a predetermined interval for seamlessly providing the search service. User equipment 200 may display the images received from service server 100 as the search result.

At step S3100, service server 100 may determine whether representative smart glasses become unable to provide images of a target search object. When the representative smart glasses becomes unable (Yes-S3100), service server 100 may reselect one from the candidate group as a new representative smart glasses at step S3080 and continuously provide images of a target search object from the new representative smart glasses at step S3090.

When the representative smart glasses still able to provide images of the target search object (No-S3100), service server 100 may determine whether a termination message is received at step S3110. When the termination message is not received (No-S3110), service server 100 may continuously provide images from the current representative smart glasses at step S3090. When the termination message is received (Yes-S3110), service server 100 may terminate the search service.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of providing a search service by a service server using a plurality of wearable computing devices registered at the service server for the search service, the method comprising:
selecting wearable computing devices located within a predetermined distance from a target search location among the registered wearable computing devices;
requesting the selected wearable computing devices to collect information on a target search object through a communication network;
receiving the requested information from the selected wearable computing devices through the communication network; and
providing the received information to user equipment that requests searching information on the target search location and the target search object.

2. The method of claim 1, comprising:
regularly receiving device information from the registered wearable computing devices through the communication network, wherein the device information includes information on at least one of a location, a traveling speed, and a time of each registered wearable computing device;
receiving a search request message from the registered user equipment; and
extracting information on the target search location and the target search object from the search request message,
wherein wearable computing devices located within a predetermined distance from the target search location are selected based on the device information of the wearable computing devices and the extracted target search location.

3. The method of claim 1, wherein the selecting comprises:
deciding a selection radius based on at least one of the target search location and the target search object; and
selecting wearable computing devices located within the decided selection radius from the target search location.

4. The method of claim 1, wherein the selecting comprises:
detecting wearable computing devices located within the predetermined distance from a location of the user equipment; and
selecting the detected wearable computing devices to request the information on the target search object.

5. The method of claim 1, wherein the receiving comprises:
analyzing the received information of each one of the selected wearable computing devices and determining whether the received information is related to the target search object;
selecting one matched with reference information from the received information related to the target search object, as a representative wearable computing device; and
requesting the representative wearable computing device to collect and provide information on the target search object.

6. The method of claim 1, wherein the receiving comprises:
analyzing the received information of each one of the selected wearable computing devices and determining whether the received information is related to the target search object;
selecting wearable computing devices providing the information related to the target search object based on the determination result;
grouping the selected candidate wearable computing devices as a candidate group;
selecting one from the candidate group as a representative wearable computing device; and
requesting the representative wearable computing device to collect and provide information on the target search object.

7. The method of claim 6, wherein the selecting candidate wearable computing devices comprises:
selecting wearable computing devices providing information on the target search object, having a same traveling speed, and located in a comparatively close distance; and
grouping the selected wearable computing devices as the candidate group.

8. The method of claim 6, comprising:
detecting the representative wearable computing device becoming unable to provide information on the target search object;
reselecting one from the candidate group as a new representative wearable computing device; and
requesting the new representative wearable computing device to collect and provide information on the target search object.

9. A method of providing a search service by a server using a plurality of smart glasses registered at the server for the search service, the method comprising:
receiving a search request message from user equipment with information on a target search object and a target search location through a communication network;
selecting smart glasses located within a predetermined distance from a target search location among the registered smart glasses;
requesting the selected smart glasses to capture and provide images of the target search object; and
receiving the requested images from the selected smart glasses and providing the received images to the user equipment as a search result.

10. The method of claim 9, wherein the receiving comprises:
regularly receiving device information from the registered smart glasses, wherein the device information includes information on at least one of a location, a traveling speed, and a time of each registered smart glasses; and
extracting information on the target search location and the target search object from the search request message,
wherein the device information and the extracted information on the target search location are used to select smart glasses located within a predetermined distance from the target search location.

11. The method of claim 9, wherein the selecting comprises:
obtaining information on a selection radius previously set based on at least one of the target search location and the target search object and stored in a memory; and
selecting smart glasses located within the decided selection radius at least one of from the target search location and the user equipment.

12. The method of claim 9, wherein the receiving comprises:
identifying objects in the images received from each one of the selected smart glasses and determining whether the identified objects are related to the target search object;
selecting one smart glasses transmitting images having the identified objects matched with reference information, as a representative smart glasses; and
requesting the representative smart glasses to capture and provide real time images of the target search object.

13. The method of claim 9, wherein the receiving comprises:
identifying objects in the images received from each one of the selected smart glasses and determining whether the identified objects are related to the target search object;
selecting, as candidate smart glasses, at least one smart glasses providing the images having the identified objects related to the target search object based on the determination result;
grouping the selected candidate smart glasses as a candidate group;
selecting one from the candidate group as a representative smart glasses; and
requesting the representative smart glasses to capture and provide real time images of the target search object.

14. The method of claim 13, wherein the grouping comprises:
selecting smart glasses providing information on the target search object, having a same traveling speed, and located in a comparatively close distance; and
grouping the selected smart glasses as the candidate group.

15. The method of claim 13, comprising:
detecting the representative smart glasses becoming unable to capture and provide images of the target search object;
reselecting one from the candidate group as a new representative smart glasses; and
requesting the new smart glasses to capture and provide real-time images of the target search object.

16. The method of claim 9, comprising:
receiving a control signal for controlling at least one of a photographing angle and a photographing distance of the selected smart glasses from the user equipment; and
requesting the selected smart glasses to capture images of the target search object based on at least one of the photographic angle and the photographing distance.

17. The method of claim 16, comprising:
receiving images, captured from at least one of the requested photographing distance and the requested photographing angle, from the requested smart glasses; and
providing the received images to the user equipment as the search result.

18. A method of searching information using a plurality of wearable computing devices, the method comprising:
transmitting a search request message to the server with information on a target search location and a target search object through a communication network; and
receiving information on the target search object from the server, as a search result,
wherein the received information is collected and provided from at least one wearable computing device located at the target search location.

19. The method of claim 18, wherein the receiving comprises:
receiving images of the target search object from the server, as the search result, wherein the images captured in real time from representative smart glasses selected from a plurality of smart glasses located within a predetermined distance from the target search location.

20. The method of claim 18, wherein the receiving comprises:
receiving a plurality of candidate images from the server, as the search result, wherein the candidate images are captured by a plurality of smart glasses located within a predetermined distance from the target search location;
receiving a user input to select one of the candidate images as a representative image and transmit the information on the representative image to the server; and
receiving images captured in real time from a smart glasses that transmits the representative image through the server.
